(19) United States
(12) Patent Application Publication
(10) Pub. No.: US 2008/0077300 A1
(43) Pub. Date: Mar. 27, 2008

(54) METHOD AND APPARATUS FOR ESTIMATING LANDSCAPE SERVICES

(76) Inventor: Robert A. Balogh, Timberlake, OH (US)

Correspondence Address: BROUSE MCDOWELL LPA, 388 SOUTH MAIN STREET, SUITE 500, AKRON, OH, 44311, US

(21) Appl. No.: 11/535,097

(22) Filed: Sep. 26, 2006

(51) Int. Cl. G06F 19/00; G06F 7/70; G06G 7/76; G06G 7/00

(52) U.S. Cl. 701/50

(57) ABSTRACT

Landscape services can be estimated by: (1) placing location transmitters around the perimeter of a parcel to be serviced, (2) transmitting location data to a receiver associated with a processing unit, and (3) using the processing unit to estimate a variable based on the area of the parcel defined by the location transmitters and one or more program input measurements associated with the devices used to provide the service. The variable may be a cost estimate, time estimate or materials estimate. The present invention replaces manual calculations of these variables.

### I. BACKGROUND OF THE INVENTION

A. Field of Invention

This invention pertains to the art of methods and apparatuses for landscaping, lawn servicing and snow removal. More specifically, this invention discloses a novel method and apparatuses for determining a variable, such as time, material, or cost, associated with the deposition or removal of material from a parcel of land.

B. Description of the Related Art

It is known in the art for those involved in providing snow removal or other similar services to manually calculate the area of the parcel to be plowed as a means of estimating the cost or time necessary to perform the service. Such calculations, namely, taking manual measurements of the parcel and any obstructions contained inside the parcel, calculating the gross and net area of the parcel to be serviced, dividing or multiplying the area by one or more of the many standard measures associated with delivering services to the parcel, including vehicle size, speed, rates and the like and ultimately estimating cost or time, can be time consuming and potentially costly since errors in performing measurements or calculations could result in severe over or underestimation of the cost, materials or time necessary to perform services on the parcel. It is particularly difficult and time consuming to accurately measure large parcels of land to be serviced. However, even small errors in the measure of these large parcels can result in significant over or under estimation of size, which can transfer into an over or under estimation of the services to be performed. While calculators or the like can be employed to assist in the actual calculations, those calculations are only as sound as the measurements and data inputs.

It is, therefore, desirable to provide apparatuses, systems and methods that can be employed in industries that service parcels of land, including parking lots, to assist in estimating the size of the parcel and additionally, providing a simple method for calculating one or more variables associated with the cost, time, or materials used in servicing the parcel. It is desirable that the system provide quick, but accurate means for estimating the size of the parcel. It is also desirable to provide the user with a processing unit that can quickly convert data pertaining to parcel area into a desired output variable based on selected, known input measures and traits associated with the devices and apparatuses used to deliver the services to the parcel. In this way, the user can program input measures and traits associated with apparatuses like plows, lawn mowers and tractors, fertilizer spreaders, salt spreaders, snow blowers, and the like and the processing unit could calculate an end variable, such as time, cost, weight or volume of material based on the estimated parcel area and the input measures selected by the user. The input measures would be selected according to the apparatus employed in servicing the parcel.

The present invention provides such a system by using location transmitters, placed around the perimeter of a parcel and any void areas, to wirelessly transmit to a receiver and associated processing unit, location points outlining the parcel, which can be processed to provide an estimate of parcel area. The associated user can select a desired variable to be estimated by the processing unit based on the estimated parcel area and the input measures selected by the user. In this way, the variable can be quickly calculated and, if necessary, multiple variables can be quickly calculated.

### II. SUMMARY OF THE INVENTION

According to one embodiment of the present invention, a new and improved method for calculating a variable associated with the delivery or removal of material to a parcel of land is provided.

According to another embodiment of the present invention, a method for calculating a variable associated with the delivery or removal of material to a parcel of land is provided, wherein the method includes using location transmitters placed around the perimeter of the parcel to transmit data to a receiver.

According to another embodiment of the present invention, a method for calculating a variable associated with the delivery or removal of material to a parcel of land is provided, wherein the method includes wirelessly transmitting data from location transmitters placed around the perimeter of the parcel to transmit data to a receiver.

According to yet another embodiment of the present invention, a method for calculating a variable associated with the delivery or removal of material to a parcel of land is provided, wherein the method includes providing a processing unit to estimate the area of the parcel based on the location data transmitted by location transmitters and based on selected input measures programmed into the processing unit.

According to still another embodiment of the present invention, the processing unit may be programmed with input measures related to the apparatuses used in servicing the parcel.

According to another embodiment of the present invention, the variable to be calculated may be time, cost, weight or volume of material to be removed or deposited onto the parcel.

According to another embodiment of the present invention, the input measures to be programmed into the processing unit may include the dimensions, speed, volume, rate of deposit, capacity of the apparatuses used in servicing the parcel.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a top view of a parcel of land having location transmitters placed around its perimeter for transmitting data to a receiver.

FIG. 2 is a side perspective view of a vehicle equipped with a receiver according to one embodiment of this invention.

FIG. 3 is a close up view of one embodiment where a transmitter is positioned on a pylon.

FIG. 4 is perspective view of the inside of the vehicle in FIG. 2 showing how, in one embodiment, the receiver and processing unit may be positioned.

### IV. DETAILED DESCRIPTION OF THE INVENTION

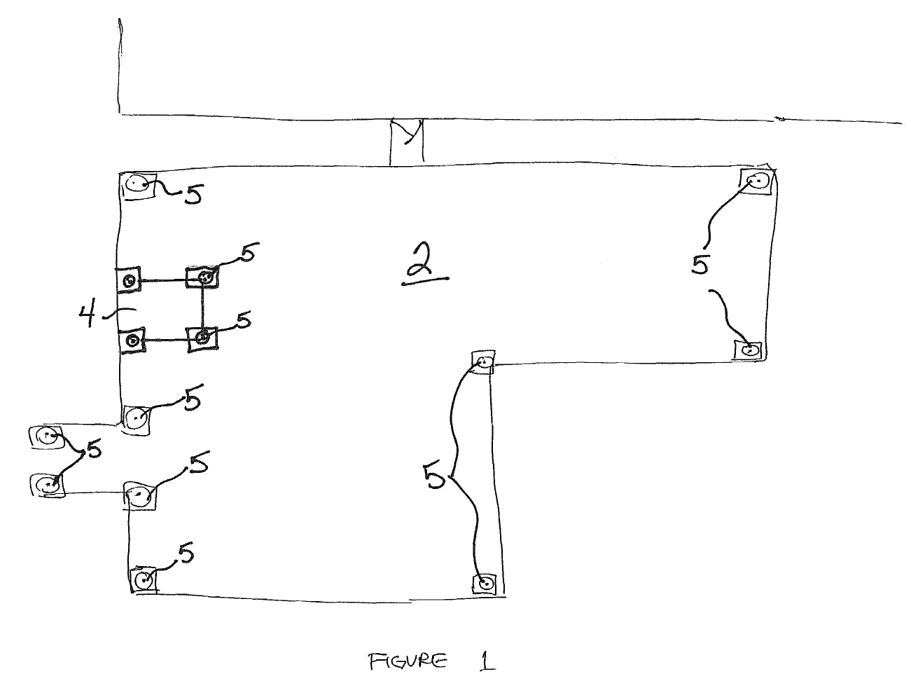

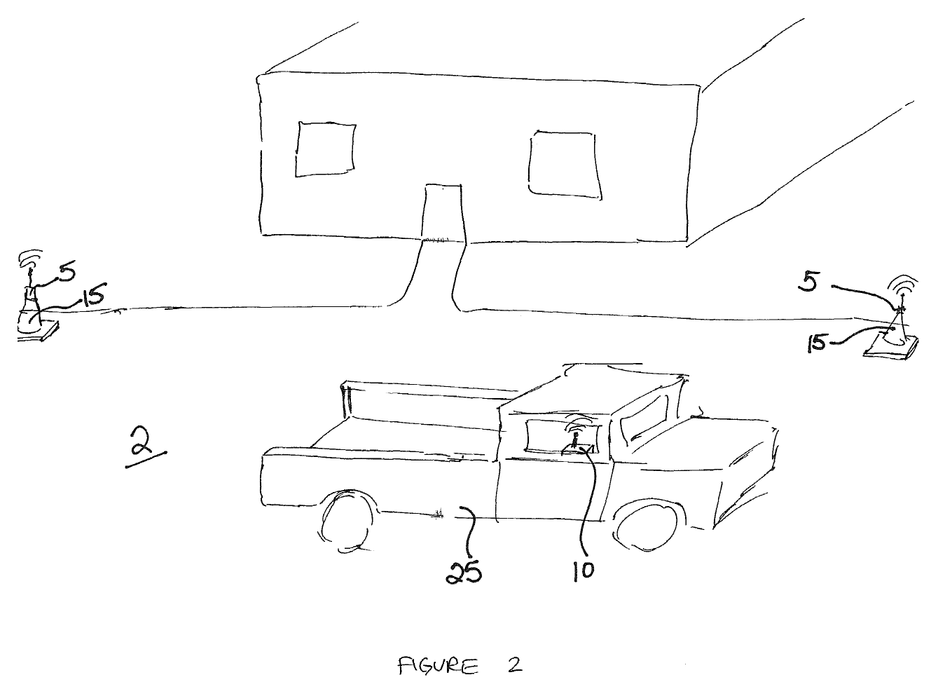

Referring now to the drawings wherein the showings are for purposes of illustrating multiple embodiments of the invention only and not for purposes of limiting the same, FIG. 1 shows a parcel of land 2 to be serviced by the removal or addition of material to the parcel. The parcel of land 2 may be a parking lot (as shown in FIG. 2). The parcel of land 2 may alternatively be a field, lawn, farm acreage, garden or the like. It is anticipated that the parcel of land 2 may include any parcel, on which it is desirable to remove or add material to it in an approximately uniform way. The material may be any material that is to be removed from a parcel of land 2, such as snow, as from a parking lot, or grass to be cut in a field. Alternatively, the material may be any material that is to be deposited on the parcel of land 2, such as rock salt to a parking lot, or fertilizer to a field. In saying that the material may be removed or added in an “approximately uniform way” it is meant that the material may be removed or added by a device 25 (see FIG. 2) having at least one substantially constant measurement that limits the rate at which the device can add or remove the material. For example, the device may be a vehicle equipped with a snowplow. The snowplow may have a given length that engages with the ground surface. The snowplow length may be substantially constant (if it is not changed during use) and this length will limit the rate that snow can be removed. Other examples of devices that remove or add material and that have at least one substantially constant measurement that limits the rate of material removal or addition include: the width of a lawn mower, the flow rate or volume of a spreader, the speed of a snow blower, the capacity of a snow blower. These examples are not intended to limit the types of devices, aspects and measurements that may be used in accordance with the present invention. The measurements may be programmed as input measurements into a processing unit (discussed below) so that the processing unit can estimate a variable for the associated user based, in part, on the input measurements or devices identified by the associated user. Additional input measurements associated with the material, such as the weight per unit area, may also be programmed into the processing unit and used in calculating a variable.

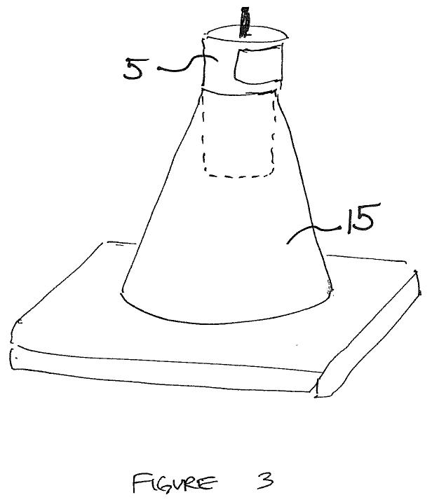

With reference now to FIGS. 1-3, a plurality of location transmitters 5 suitable for identifying and transmitting data about their respective locations may be placed around the perimeter of the parcel 2. In one embodiment, the location transmitters 5 are global positioning transmitters that transmit longitude and latitude data. In other embodiments, the location transmitters 5 may be any type or style of location transmitters having the capability of recognizing and transmitting their relative positions. As noted above, a plurality of location transmitters 5 may be placed at selected points around the perimeter of the parcel 2. Any means for placing the location transmitters 5 around the perimeter of the parcel 2 may be selected with sound engineering judgment. In one embodiment, the location transmitters 5 may be provided with stakes for removably placing the location transmitters 5 in the ground. In another embodiment, shown, the location transmitters 5 may be provided on standard safety cones or pylons 15 which can be placed at locations around the perimeter of the parcel 2. In yet another embodiment, the location transmitters 5 may be placed directly on the ground surface. It is intended that a sufficient number of location transmitters 5 be placed around the perimeter of the parcel 2 to allow for a calculation of the area of the parcel 2 enclosed by the points selected for the location transmitters 5. Thus, it is anticipated that at least three location transmitters 5 will be placed in accordance with the present invention. However, more than three location transmitters 5 may be placed in order to define an area which is a quadrilateral or otherwise non-triangular in shape.

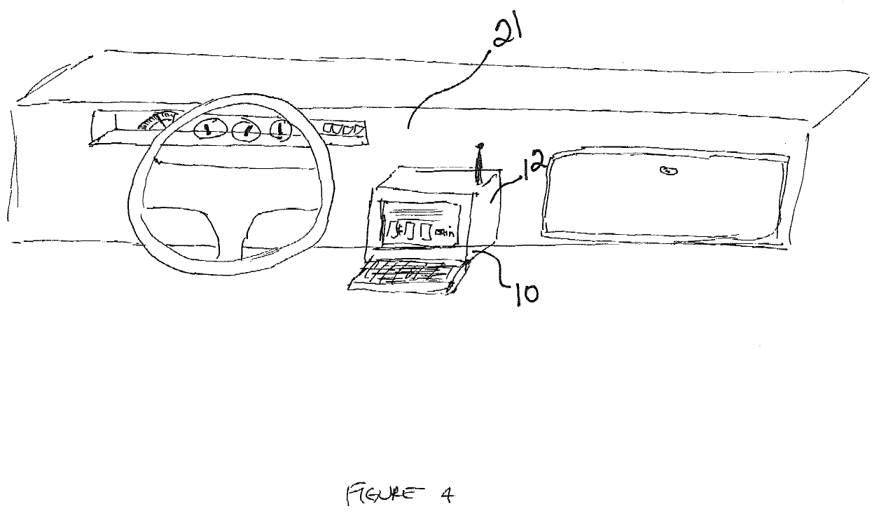

With reference now to FIGS. 1-4, the location transmitters 5 transmit data to at least one receiver 10. In one embodiment, the receiver 10 may be positioned near to the location of the transmitters 5. In another embodiment, the receiver 10 may be positioned remote from the location of the transmitters 5. The receiver 10 may, in one embodiment, be located in or on an associated vehicle 25 as shown in FIGS. 2 and 4 where the receiver is mounted near the dashboard 21. In another embodiment, the receiver 10 may be located in a dispatch office or other remote location. A processing unit 12 for processing the data received by the receiver 10 from the location transmitters 5 may be provided. In one embodiment, shown, the receiver 10 and processing unit 12 are positioned within a common housing. In another embodiment, the processing unit 12 may be positioned remote from the receiver 10. In yet another embodiment, the receiver 10 and/or processing unit 12 may be within a handheld device. The data that may be transmitted from the location transmitters 5 to the receiver 10 may be location data, including the latitude and longitude of the transmitter. In one embodiment, the location transmitter may be provided with an associated altimeter (not shown) that can measure altitude. For this embodiment, data that may be transmitted to the receiver 10 may also include altitude. In yet another embodiment, the location transmitter 5 may be provided with means for measuring the depth of material, such as, for example, snow, to be removed from the parcel 2. In this embodiment, data that may be transmitted to the receiver 10 may include a depth measurement.

With continuing reference to FIGS. 1-4, after the data has been transmitted to the receiver 10, the processing unit 12 may calculate the area of the parcel 2 based on the location data transmitted by the location transmitters 5. Specifically, the points selected for the location transmitters 5 will define a geographic area. The processing unit 12 may use the distances between the location transmitters 5 to estimate the area of the parcel. Alternatively, each location transmitter 5 may be adapted to measure the distance between itself and the other or selected other location transmitters 5. These inter-distance measurements may be transmitted to the receiver 10 by the location transmitters 5. In this way, the processing unit 12 may not need to calculate the distance between the location transmitters 5 as a means of estimating the area of the parcel 2, these distances will be provided by the location transmitters 5. The processing unit 12 may additionally calculate a variable based on the calculated area of the parcel 2 and one or more input measurements, which are discussed above. The input measurements may relate to aspects of the device or devices 25 to be used in removing or adding material to the parcel 2. The variables that may be calculated by the processing unit 12 may include time, number of passes, volume, weight and cost. Other variables may be calculated depending on the input measurements selected.

Still referring to FIGS. 1-4, exemplary of a calculation of a variable by the processing unit 12, a user may use the processing unit 12 to calculate the time for mowing a lawn based on the area of the parcel 2 as calculated from the location data transmitted by the location transmitters 10, the width of the lawn mower used in mowing the lawn, which may be n input measurement, and the speed of the lawn mower, which may be a second input measurement. In another example, a user may use the processing unit 12 to calculate the weight of salt to put onto a parking lot based on the area of the parcel 2 as calculated from the location data transmitted by the location transmitters 10 and the input measurement of the desired weight per unit area of salt desirable for the application. In a third example, a user may use the processing unit 12 to prepare an estimate of the cost of removing snow from a parking lot based on area of the parcel 2 as calculated from the location data transmitted by the location transmitters 10 and the effective rate of snow removal of the snow removal apparatus, which may be an input measurement and the unit cost of the snow removal apparatus, which may be another input measurement. There may be a variety of input measurements programmed into the processing unit 12. Alternatively, the processing unit 12 may be provided with the capability for inputting additional input measurements.

In areas that are hilly or mountainous, it may be necessary to incorporate altitude data into the computation of the area of the parcel 2 in order to obtain a more accurate estimate of the area of the parcel 2. Alternatively, it may be advantageous to have a measure of the depth of material to be removed from the parcel 2 since the depth of the material may be a non-constant measurement that can affect the calculation of the variable of interest. In particular, the amount of snow that is on a parcel 2 may affect the cost or time for removal. In this case, means for measuring the depth of snow at the location transmitters 5 may be transmitted to the receiver 10 and used by the processing unit 12 to calculate the variable. The processing unit 12 may be associated with an output apparatus for displaying the calculated variable.

As shown in FIG. 1, it may be necessary to exclude one or more void areas 4 in the parcel 2 from the addition or removal of material. Such void areas 4 may include, but are not limited to trees, buildings, and parking lot benns. A void area 4 may be any area in the parcel 2 where it is desirable not to remove or add material or where it is impractical or impossible to remove or add material to such an area. In this situation, location transmitters 5 may be placed around the perimeter of the parcel 2 and around the void areas 4. The processing unit 12 may receive the location data from the location transmitters 4 and calculate a net parcel area by subtracting the sum of the void areas 4 from the parcel area 2. In this way, an associated user will be able to calculate a variable based on the net parcel area.

With reference again to FIGS. 1-4, In one embodiment, a method of the present invention may involve the steps of placing a plurality of location transmitters 5 at selected points around the perimeter of a parcel 2 on which material is to be added or removed. Location transmitters 5 may be placed approximately at the corners of the parcel 2 and at the nadir or apex of any curved perimeter lines or undulations. At least two location transmitters 5 may be placed along each perimeter line and at least three location transmitters 5 may be placed on the perimeter of the parcel 2, though at least four location transmitters 5 may be appropriate for quadrilaterally shaped parcels. More than four location transmitters 5 may be used depending on the desired accuracy of the calculation of the parcel area or the complexity of the perimeter of the parcel 2. Location transmitters 5 may be placed around void areas 4 as described above.

With continuing reference to FIGS. 1-4, after the location transmitters 5 have been placed, data concerning the location of each of the location transmitters 5 may be transmitted to the receiver 10, which may be in a vehicle 25. If the location transmitters 5 are provided with associated altimeters, data concerning elevation may be transmitted to the receiver 10. Data transmitted to the receiver 10 may be communicated to the processing unit 12. The processing unit 12 may calculate the gross area of the parcel 2 based on the location data of the location transmitters 5 placed on the perimeter of the parcel 2. The location transmitters 5 may be provided with a unique marker, such as a digital marker, in order to allow the processing unit 12 to distinguish between the location transmitters 12. The processing unit 12 may calculate the void areas 4 based on the location data of the location transmitters 5 placed on the perimeters of the void areas. The processing unit 12 may calculate the net parcel area by subtracting the void areas 4 from the gross parcel area 12.

Still referring to FIGS. 1-4, the processing unit 12 may be adapted for receiving input measurements or may be programmed with input measurements. The associated user may communicate with the processing unit 12 to have the processing unit 12 calculate a variable based on the calculated net parcel area and the selected input measurements. The variable may be communicated to the associated user by a display or any other means to convey the variable. In this way, an associated user can estimate a variable or a variety of variables on parcels of all size without having to take any manual measurements of the parcel 2 or having to make any manual calculations.

Multiple embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A method for estimating a variable associated with the removal or addition of material to a parcel of land, the method comprising:
providing a parcel of land on which material is to be removed or added;
placing a plurality of location transmitters around the perimeter of the parcel of land;
transmitting a location point of each of the plurality of location transmitters to a receiver having an associated processing unit;
using the processing unit of the receiver to estimate the area of the parcel of land based on the location points transmitted to the receiver;
using the processing unit of the receiver to estimate the variable based on the estimated area of the parcel of land and at least a first input measurement selected by an associated user.

2. The method of claim 1, wherein the step of transmitting the location point of each of the plurality of location transmitters to the receiver having the processing unit involves wirelessly transmitting the location points of the plurality of location transmitters.

3. The method of claim 2, wherein the location transmitters are global positioning transmitters, and wherein the receiver is located inside a vehicle.

4. The method of claim 2, wherein the receiver is a hand-held receiver.

5. The method of claim 1, wherein the variable to be estimated is selected from the group consisting of: time for adding or removing material from the parcel of land, cost of adding or removing material from the parcel of land, volume of material added to or removed from the parcel of land, and weight of material added to or removed from the parcel of land.

6. The method of claim 5, wherein the first input measurement is a measurement of a device used to add or remove material from the parcel of land.

7. The method of claim 6, wherein the first input measurement is the width of a plow used to remove snow from the parcel of land.

8. A method for estimating a variable associated with the removal or addition of material to a parcel area of land, the method comprising:
providing a parcel of land on which material is to be removed or added;
placing a plurality of location transmitters around the perimeter of the parcel of land;
Placing a plurality of location transmitters around the perimeter of voids that are located within the perimeter of the parcel of land;
transmitting a location point of each of the plurality of location transmitters to a receiver having an associated processing unit;
using the processing unit of the receiver to estimate a total area of the parcel of land;
using the processing unit of the receiver to estimate a void area, wherein the void area is the sum of the areas defined by the perimeters of the voids,
using the processing unit of the receiver to estimate net parcel area;
using the processing unit of the receiver to estimate a variable based on the estimated net parcel area and at least a first input measurement selected by an associated user.

9. The method of claim 8 wherein the material is selected from the group consisting of snow, salt, fertilizer, soil additives, clippings, dirt, and sand.

10. The method of claim 9 wherein the processing unit is pre-programmed with input measurements.

11. The method of claim 10 wherein the processing unit is in communication with a display device for displaying the variable.

12. The method of claim 11, wherein the location transmitters further comprise an altimeter.

13. The method of claim 8, wherein the step of using the processing unit of the receiver to estimate the total area of the parcel of land further involves the steps of determining the distances between the location transmitters placed on the perimeter of the parcel, selecting a set of distances, and mathematically combining the set of selected distances.

14. A method for estimating a variable associated with the removal of snow from a parcel of land, the method comprising:
providing a parcel of land on which snow is to be removed;
placing a plurality of location transmitters around the perimeter of the parcel of land;
Placing a plurality of location transmitters around the perimeter of any void that is located within the perimeter of the parcel of land;
transmitting a location point of each of the plurality of location transmitters to a receiver having an associated processing unit;
using the processing unit of the receiver to estimate a total area of the parcel of land;
using the processing unit of the receiver to estimate a void area, wherein the void area is the sum of the areas defined by the perimeters of the voids,
using the processing unit of the receiver to estimate net parcel area, wherein the net parcel area is the difference between the total area of the parcel of land and the void area;
selecting at least a first input measurement on the processing ullit, wherein the input measurement is an input measurement associated with a snow-removal device;
using the processing unit of the receiver to estimate the variable based on the estimated net parcel area and the at least a first input measurement.

15. The method of claim 14, wherein the variable is cost for removing snow from the parcel of land.

16. The method of claim 14 wherein the variable is time for removing snow from the parcel of land.

17. The method of claim 16, wherein the at least a first input measurement is the width of a snowplow blade.

18. The method of claim 17, further comprising the step of selecting at least a second input measurement, and
wherein the processing unit of the receiver is used to estimate the variable based on the estimated net parcel area, the at least a first input measurement and the at least a second input measurement.

19. The method of claim 18, wherein the at least a second input measurement is the speed of a plow.
